(19) United States
(12) Patent Application Publication
(10) Pub. No.: US 2007/0071400 A1
(43) Pub. Date: Mar. 29, 2007

(54) Video display device and video reproduction method

(75) Inventor: Riichiro Yoshida, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/523,662

(22) Filed: Sep. 20, 2006

(30) Foreign Application Priority Data
Sep. 28, 2005 (JP) 2005-281606

(51) Int. Cl. H04N 5/91

(52) U.S. Cl. 386/83

(57) ABSTRACT

A video display device including a receiving unit which receives a video signal, a signal processing unit which subjects the video signal received by the receiving unit to predetermined signal processing, a display unit which displays the video signal output from the signal processing unit, a recording and reproducing unit which stores the video signal output from the signal processing unit, an image information extracting unit which extracts information of a program received by the receiving unit, an image processing control unit which controls the signal processing performed by the signal processing unit, and a program management list setting unit which links information of a program to be first viewed, which is extracted by the program information extracting unit, with the image processing control information set by the image processing control unit.

### CROSS-REFERENCE TO RELATED APPLICATIONS

This application is based upon and claims the benefit of priority from Japanese Patent Application No. 2005-281606, filed Sep. 28, 2005, the entire contents of which are incorporated herein by reference.

### BACKGROUND

1. Field

One embodiment of the invention relates to a video display device and a video reproduction method, more particularly to an improvement in a video reproduction method where an already viewed program is viewed again.

2. Description of the Related Art

As is well known, in recent years, a switch to digital television broadcasting has been promoted. For example, in Japan, not only digital direct broadcasting by satellite but also terrestrial digital broadcasting have started.

In digital television broadcasting, in contrast with analog television broadcasting, since data is compressed, it is possible to broadcast multi-channel high-definition content (program). In recent years, owing to an increase in the capacity of an HDD, a television receiver having a function of recording digital television broadcasts has also been developed.

Moreover, in the conventional television receiver, a function of setting various image quality, has been added, the image quality being adjustable in accordance with a user's taste.

However, in the conventional television receiver, the image quality is set by a manual operation while the user confirms displayed video with the naked eye. This has been laborious because it is necessary to adjust the image quality into an optimum image quality in accordance with individual sources. To solve the problem, there are proposed a video display device and a video reproduction method in which a signal is processed based on a parameter correspondence table stored beforehand in accordance with video coding information of the program (see Patent Document of Jpn. Pat. Appln. KOKAI Publication No. 2001-326876).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a signal processing system of a video display device in an embodiment of this invention;

FIG. 2 is a block diagram showing basic elements extracted from a characteristic section in this invention;

FIG. 3 is a block diagram showing a constitution example of video processing means shown in FIG. 2;

FIGS. 4A to 4C are explanatory views showing conversion examples of display image levels in the video display device of the present invention;

FIG. 5 is an explanatory view showing a constitution example of a program management list in the embodiment of this invention;

FIG. 6 is a flowchart showing an operation of a control unit in the embodiment of this invention;

FIG. 7 is an explanatory view showing a constitution example of the program management list in another embodiment of this invention; and

FIG. 8 is a flowchart showing an operation of a control unit in the other embodiment of this invention.

### DETAILED DESCRIPTION

Various embodiments according to the invention will be described hereinafter with reference to the accompanying drawings.

An object of one embodiment of this invention is to provide a video display device and a video reproduction method in which image processing control information during previous viewing is stored, and a viewed program can be reproduced using the image processing control information in a case where the viewed program stored in an HDD is reproduced.

Moreover, an object of another embodiment is to provide a video display device and a video reproduction method in which image processing control information during previous viewing is stored beforehand, and a series of programs can be viewed using the image processing control information in a case where the series of programs which have been viewed in the past are viewed.

One embodiment of this invention has: receiving means for receiving a video signal; signal processing means for subjecting the video signal received by the receiving means to predetermined signal processing; video signal output means for outputting the video signal output from the signal processing means to display means for displaying the video signal; a recording and reproducing unit which stores the video signal output from the signal processing means in a recording medium; program information extracting means for extracting information of a program received by the receiving means; image processing control means for controlling the signal processing performed by the signal processing means; and program management information setting means for storing program management information obtained by associating information of a program to be first viewed, which is extracted by the program information extracting means, with the image processing control information set by the image processing control means.

Another embodiment of this invention has: receiving means for receiving a video signal; signal processing means for subjecting the video signal received by the receiving means to predetermined signal processing; video signal output means for outputting the video signal output from the signal processing means to display means for displaying the video signal; a recording and reproducing unit which stores the video signal output from the signal processing means in a recording medium; program information extracting means for extracting information of a program received by the receiving means; image processing control means for controlling the signal processing performed by the signal processing means; and program management information setting means for storing program management information obtained by associating information of a program to be first viewed, which is extracted by the program information extracting means, with the image processing control information set by the image processing control means.

There will be described hereinafter embodiments of this invention with reference to the drawings.

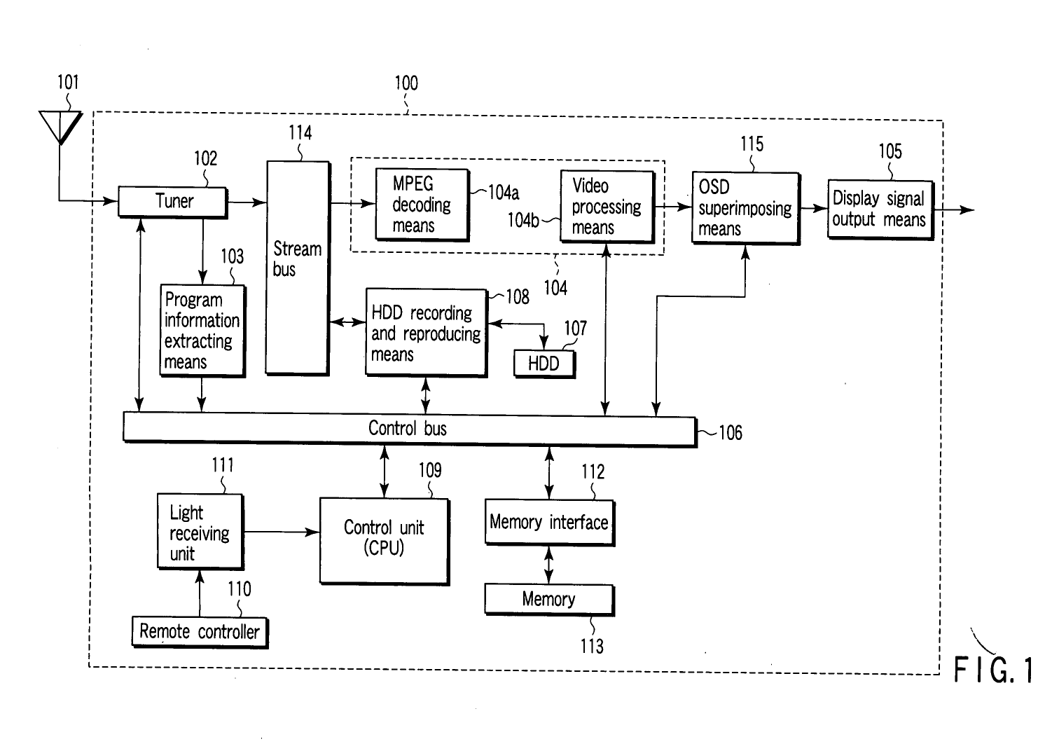

FIG. 1 shows main signal processing of a video display device 100 in this invention. A digital broadcasting signal received by an antenna 101 is supplied to a tuner 102. The tuner 102 selects, from the supplied digital broadcasting signals, a signal of a desired channel by the control of a control unit (CPU) 109, and outputs a transport stream (TS) signal to signal processing means 104 and HDD recording and reproducing means 108 via a stream bus 114. Moreover, program information extracting means 103 extracts program information from the digital broadcasting signal supplied from the tuner 102.

The signal processing means 104 has MPEG decoding means 104a and video processing means 104b. The MPEG decoding means 104a decodes a supplied TS signal, and outputs the signal to the video processing means 104b. The video processing means 104b subjects the supplied MPEG decoded image signal to signal processing under the control of the control unit (CPU) 109, outputs a display image signal to an on-screen display (OSD) superimposing means 115, generates an OSD image under the control of the CPU 109, and superimposing the image upon the display image to supply the signal to display (video) signal output means 105. The display signal output means 105 outputs the supplied display image signal to a display unit.

Moreover, the stream bus 114 is connected to a recording and reproducing device (HDD) 107. In the HDD 107, the HDD recording and reproducing means 108 records the TS signal supplied from the tuner 102, and reproduces the recorded program. Furthermore, program management information (hereinafter referred to as the program management list as one example) is recorded in the HDD 107. The program management list will be described later in detail.

When the digital broadcasting signal is viewed as such, the TS signal output from the tuner 102 is supplied to the signal processing means 104 via the stream bus 114. When the digital broadcasting signal is recorded in the HDD 107, the TS signal output from the tuner 102 is supplied to the HDD recording and reproducing means 108 via the stream bus 114. When the program recorded in the HDD 107 is reproduced, the stream bus 114 operates so that the TS signal output from the HDD 107 is supplied to the signal processing means 104 via the stream bus 114.

A control bus 106 transmits a control signal, coding information and the like between functions of this video display device 100.

Here, all operations of this video display device 100 including various types of receiving operations described above are generally controlled by the CPU 109. When the CPU 109 receives operation information sent by a remote controller 110 via a light receiving unit 111, the CPU controls each unit so that operation contents are reflected in the device.

It is assumed that in the present embodiment, the program management list is recorded in the HDD 107, but a memory I/F 112 may be disposed so that the list is recorded in a memory 113 constituted of a nonvolatile memory such as an electronically erasable and programmable read only memory (EEPROM) or a flash memory.

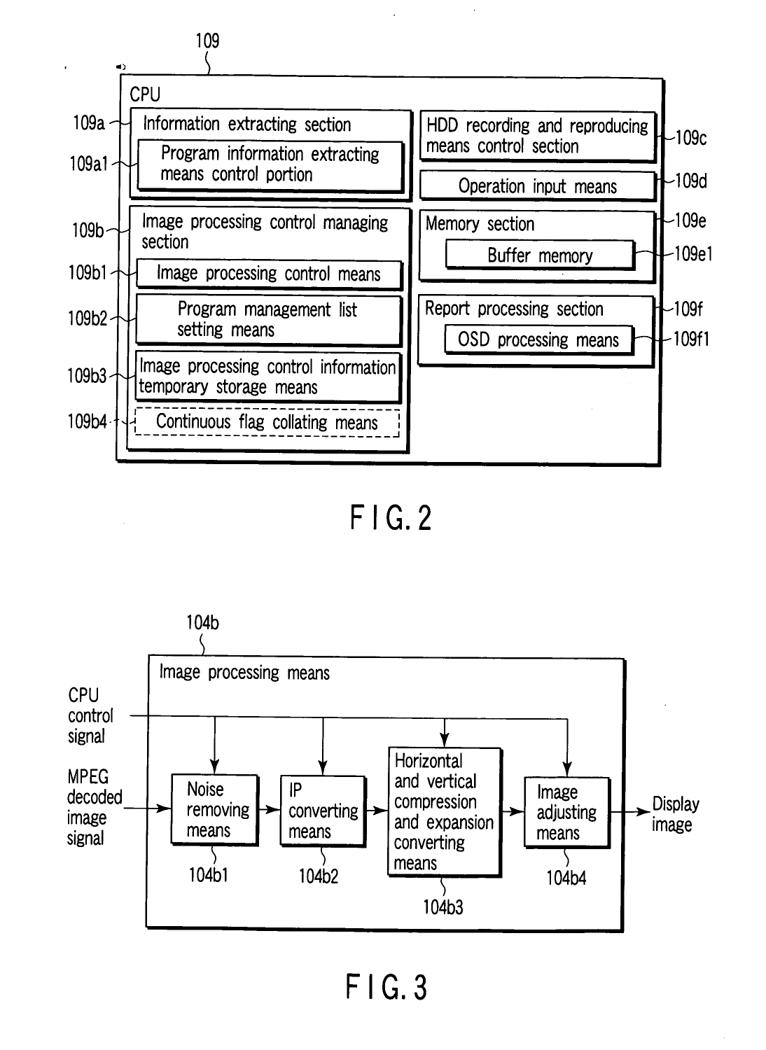

FIG. 2 is a block diagram showing a constitution example of the CPU 109 which is a characteristic unit in this invention.

The CPU 109 has a program information extracting section 109a which extracts information of the received program. This program information extracting section 109a includes a program information extracting means control portion 109a1. The program information extracting means control portion 109a1 controls the program information extracting means 103, and acquires the program information.

Moreover, the CPU 109 has an image processing control managing section 109b. This image processing control managing section 109b has image processing control means 109b1 for controlling signal processing performed in the signal processing unit 104 of FIG. 1. The image processing control managing section also has program management list setting means 109b2 for linking the program information with the image processing control information set by the image processing control means 109b1 in a case where this program is first viewed, thereby preparing the program management list. The image processing control managing section further has image processing control information temporary storage means 109b3 for temporarily storing the image processing control information of a program being viewed in a case where the viewed program recorded in the HDD 107 is reproduced. After completing the reproduction of the viewed program, the means can read the temporarily stored image processing control information to set the information to the signal processing means 104.

Furthermore, the CPU 109 includes the following blocks: HDD recording and reproducing means control section 109c which controls the HDD recording and reproducing means 108; operation input means 109d for controlling each component so that operation contents of operation information are reflected in the device, when the operation information sent from the remote controller 110 is received via the light receiving unit 111; a memory section 109e including a buffer memory 109e1 which is a working area of the CPU 109; and a report processing section 109f. This report processing section 109f includes OSD processing means 109f1 capable of superimposing processing results, program information and the like upon the display image by the OSD superimposing means 115, and displaying the image in a display unit via the display signal output means 105. The means controls selection of a character control code, an icon image or the like for generating an OSD video by the OSD superimposing means 115.

FIG. 3 is a block diagram showing a constitution example of video processing means 104b shown in FIG. 1. Now, in the video processing means 104b, there is input the MPEG decoded image signal decoded by the MPEG decoding means 104a. Noise removing means 104b1 removes a noise signal mixed in the supplied MPEG decoded image signal, and outputs the signal to an IP converting means 104b2. When the supplied image signal is of an interlaced scanning system, the IP converting means 104b2 successively converts the system into a progressive scanning system. When the signal is of the progressive scanning system, the image signal is output as such to horizontal and vertical compression and expansion converting means 104b3. The horizontal and vertical compression and expansion converting means 104b3 converts a display image level of the supplied image signal, and outputs the image to image quality adjusting means 104b4. The image quality adjusting means 104b4 adjusts, for example, brightness, contrast and the like of the image signal, and outputs the display image signal to the OSD superimposing means 115.

Here, the image processing control means 109b1 shown in FIG. 2 controls an on/off state of the noise removing means 104b1, the display image level of the horizontal and vertical compression and expansion converting means 104b3, and an image quality setting of the image quality adjusting means 104b4.

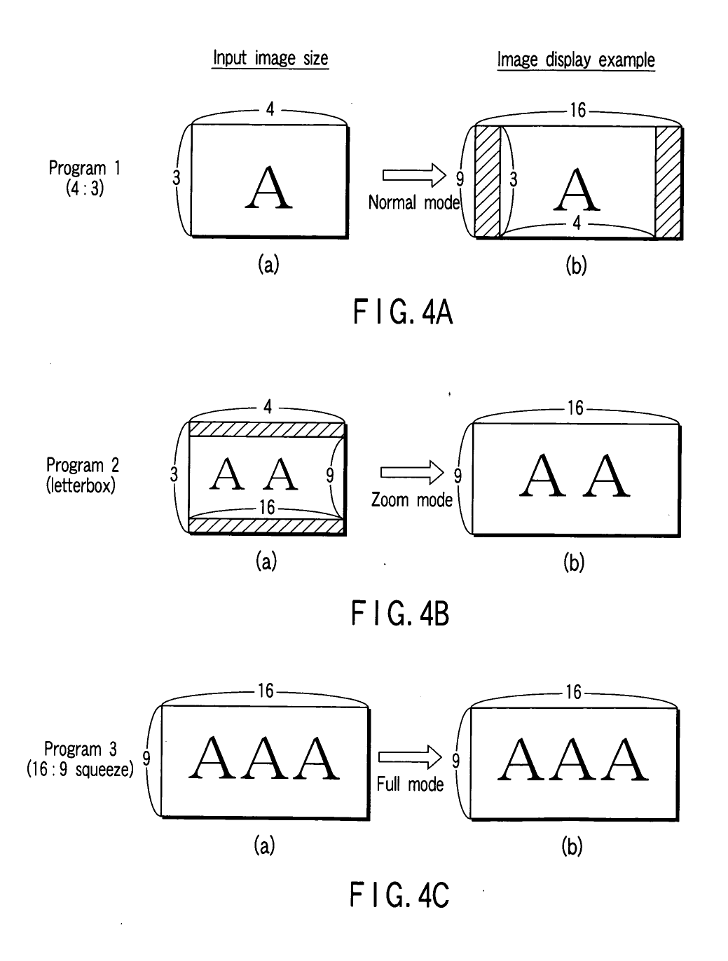

FIGS. 4A to 4C are explanatory views showing conversion examples of display image levels in the horizontal and vertical compression and expansion converting means 104b3. FIG. 4A shows an example in which an image signal of a program 1 having an image aspect ratio of 4:3 is supplied to the horizontal and vertical compression and expansion converting means 104b3. An input 4:3 image signal (a) is not subjected to image level conversion processing (normal mode), and an image is displayed in a screen having a ratio of 16:9 as shown in (b). Black bands are displayed on outer sides of an image region.

FIG. 4B shows an example in which an image signal of a program 2 as a letter box is supplied to the horizontal and vertical compression and expansion converting means 104b3. As to an input letter box image signal (a), an image region is zoomed (zoom mode), and an image is displayed fully in a screen having a ratio of 16:9 as shown in (b). FIG. 4C shows an example in which an image signal of a program 3 as squeeze is supplied to the horizontal and vertical compression and expansion converting means 104b3. An input squeeze image signal (a) is extended fully in a screen (full mode), and an image is displayed as shown in (b).

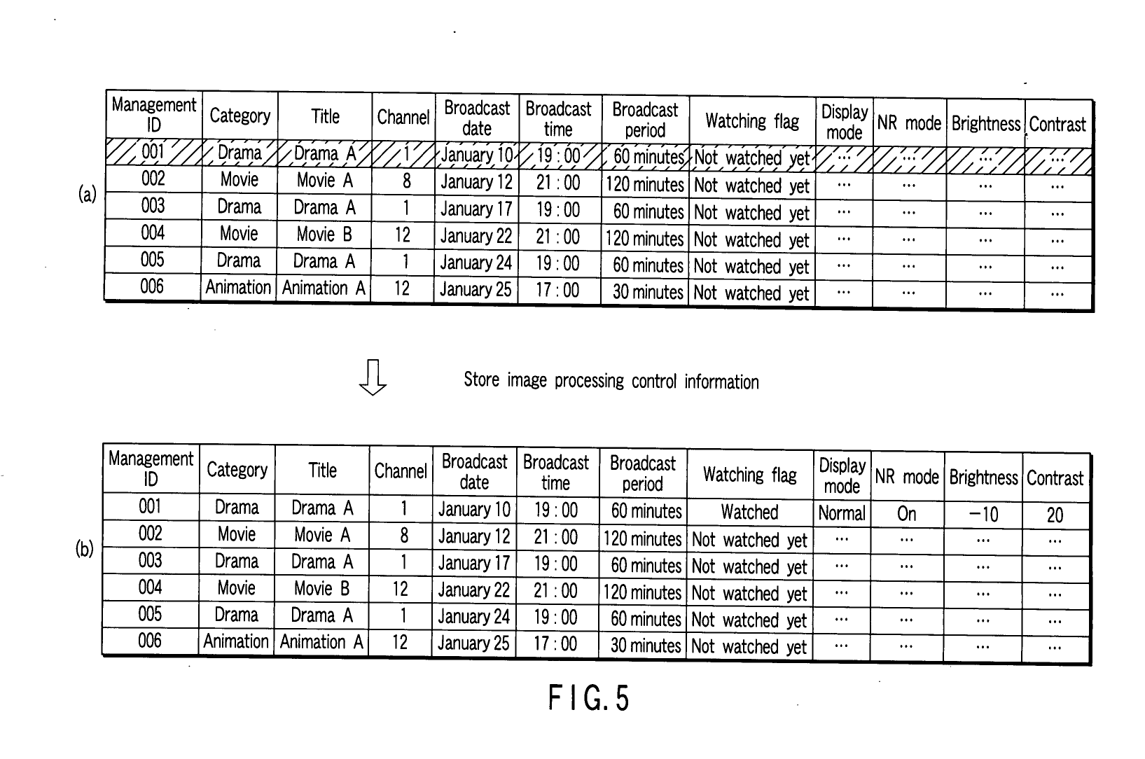

FIG. 5 is an explanatory view showing a specific example of an operation of the program management list setting means 109b2 in the present embodiment. A management ID is recognized information allocated to the program. A viewing flag indicates whether or not the program has already been viewed. Furthermore, a display mode, an NR mode, brightness and contrast show set values of an image processing control executed by the image processing control means 109b1, respectively.

It is to be noted that the image processing control information is largely divided into two pieces of information: one pieces is information on the display image level; and the other piece is information on image quality adjustment. As the image processing control information of the present invention, it is possible to use information on the display mode (mode of the display image level), the NR mode (noise reduction mode), the brightness, and the contrast as shown in FIG. 5, and information on hue, chroma, sharpness or the like.

A program management list (a) indicates that a user now inputs an operation to view a drama A of a row (management ID 001). When the user first views the drama A, the viewing flag changes to “viewed”. Furthermore, as in the row (management ID 001) of a program management list (b), the presently set image processing control information is linked with the information of the program, and stored in the program management list.

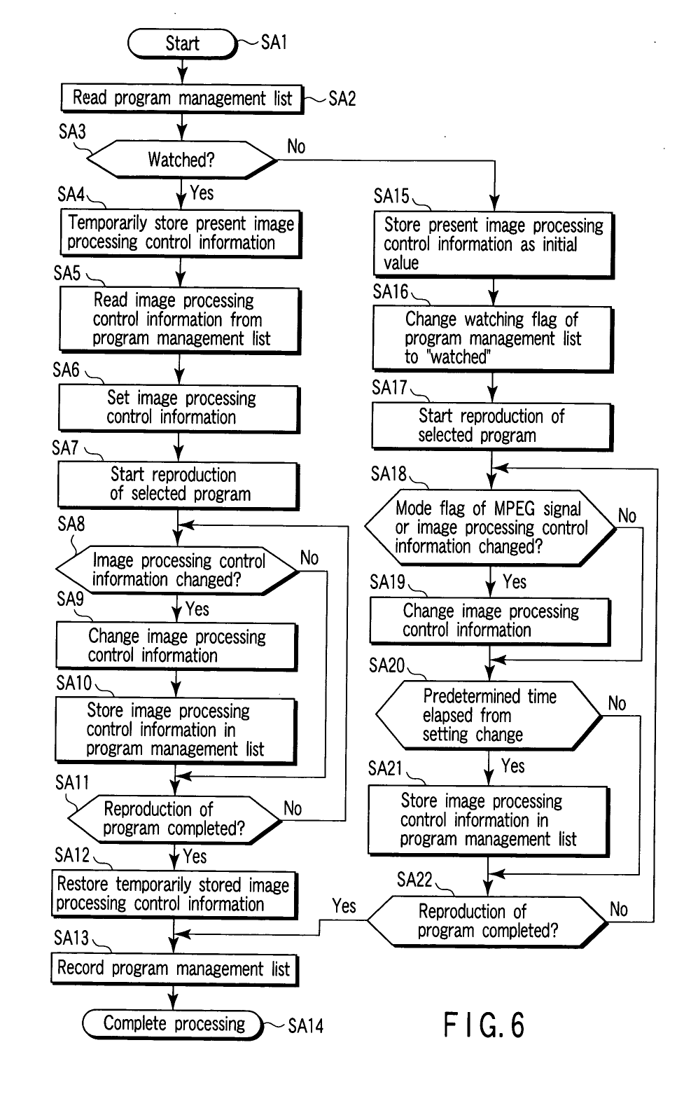

FIG. 6 is a flowchart showing a specific operation example of the image processing control managing section 109b in the present embodiment. Now it is assumed that an operation is input to reproduce the program recorded in the HDD 107 (step SA1). The program management list setting section 109b2 reads the program management list from the HDD 107 (step SA2), and judges whether or not the program has been viewed (step SA3). In a case where the program has been viewed, the image processing control information temporary storage means 109b3 temporarily stores the presently used image processing control information (step SA4). The image processing control means 109b1 reads the image processing control information of the program from the program management list (step SA5), and sets the information to the video processing means 104b (step SA6). The HDD recording and reproducing means control section 109c starts reproduction of the program (step SA7).

In a case where a change of the image processing control information is input into the operation input means 109d during the viewing of the program (step SA8), the image processing control means 109b1 sets the changed image processing control information to the video processing means 104b (step SA9). The program management list setting means 109b2 updates the image processing control information of the program management list into the changed image processing control information (step SA10). In a case where any change of the image processing control information is not input in the step SA8, the processing advances to step SA11. In a case where the reproduction of the program is not completed in the step SA11, the processing loops to the step SA8. The operation of the steps SA8 to SA11 loops until the reproduction of the program is completed.

In a case where the reproduction of the program is completed in the step SA11, the image processing control means 109b1 calls the image processing control information temporarily stored in the image processing control information temporary storage means 109b3, and sets the information to the video processing means 104b (step SA12). Moreover, the control means stores the prepared program management list in the HDD 107 (step SA13), thereby completing the processing (step SA14).

Moreover, in a case where it is judged in the step SA3 that the program to be reproduced has not been viewed, the program management list setting means 109b2 links the presently used image processing control information with the program ID to record the information in the program management list (step SA15), and the means changes the viewing flag to “viewed” (step SA16). The HDD recording and reproducing means control section 109c starts the reproduction of the program (step SA17).

It is monitored in step SA18 whether or not the mode flag of the MPEG signal is changed or a change of the image processing control information by the operation input means 109d is input during the viewing of the program. In a case where there is a change in the step SA18, the image processing control means 109b1 sets the changed image processing control information to the video processing means 104b (step SA19). In a case where there is not any change in the step SA18, the processing advances to step SA20.

It is monitored in the step SA20 whether or not a certain time has elapsed after the change of the image processing control information is input (step SA20). In a case where it is judged in the step SA20 that the certain time has elapsed, the program management list setting means 109b2 updates the image processing control information of the program management list into the changed image processing control information (step SA21). In a case where it is judged in the step SA20 that the certain time has not elapsed, the changed image processing control information is not updated in the program management list, and the processing advances to step SA22. In a case where it is judged in step SA22 that the reproduction of the program is not completed, the processing loops to the step SA18, and a state in which the image processing control information can be changed is brought about. The operation of the steps SA18 to SA22 loops until the reproduction of the program is completed.

In a case where it is judged in the step SA22 that the reproduction of the program is not completed, the prepared program management list is stored in the HDD 107 (step SA13), thereby completing the processing (step SA14).

Here, the temporarily stored image processing control information of the step SA12 is image processing control information temporarily stored in the step SA4. For example, it is assumed that a program B using image processing control information B is reproduced in a state in which a program A is set by image processing control information A is viewed. In this case, the image processing control information temporary storage means 109b3 temporarily stores the image processing control information A, and the image processing control means 109b1 sets the image processing control information B during the reproduction of the program B. After the reproduction of the program B is completed, the image processing control means 109b1 calls the image processing control information A temporarily stored by the image processing control information temporary storage means 109b3 to set the information.

This invention is not limited to the above embodiment. The program management list may include a continuous flag indicating a series of programs, and continuous flag collating means 109b4 may be added to the image processing control managing section 109b of the CPU 109 shown in FIG. 2.

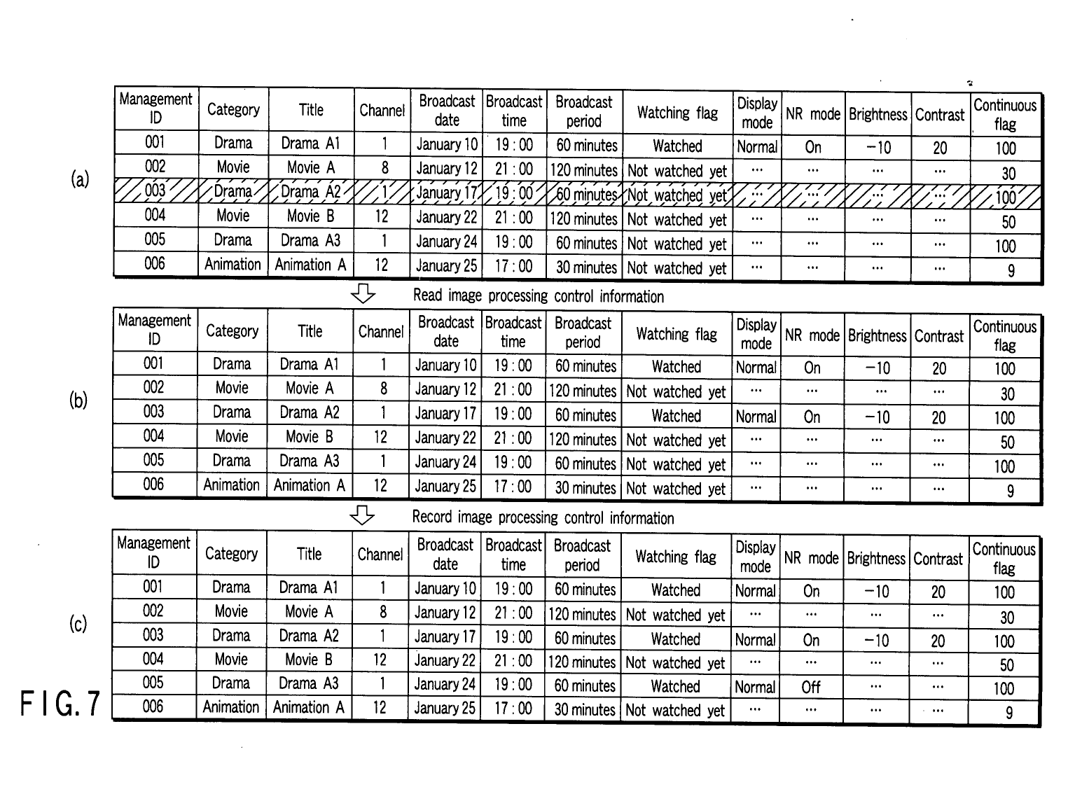

FIG. 7 is an explanatory view showing a specific example of an operation of program management list setting means 109b2 in another embodiment. Here, a program management list includes a continuous flag.

A program management list (a) indicates that an operation that a user now views a drama A2 has been input. It is seen from the continuous flag that a drama A1, the drama A2 and a drama A3 are a series of programs. The user has viewed the drama A1 other than the drama A2 in the series of programs. Therefore, the program management list setting means 109b2 copies the image processing control information of the drama A1 to that of the drama A2 as shown in a list (b). When the drama A3 is viewed, the image processing control information of the drama A2 is similarly copied, and the drama A3 is reproduced. However, in a case where the image processing control information is changed during the reproduction of the drama A3, the image processing control information of the drama A3 is updated into changed information, and recorded in the program management list as shown in (c).

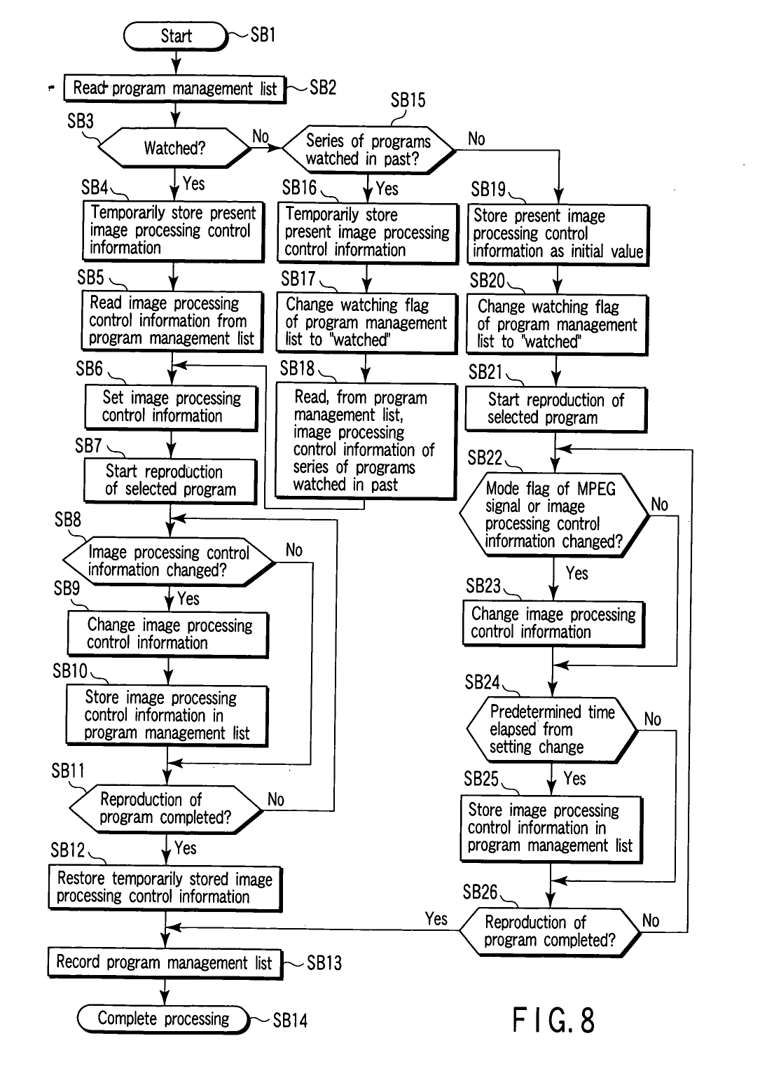

FIG. 8 is a flowchart showing a specific operation example of the image processing control managing section 109b in the other embodiment of this invention. Here, the image processing control managing section 109b includes the continuous flag collating means 109b4. It is to be noted that steps SB1 to SB14 are similar to the steps SA1 to SA14 shown in FIG. 6. Since steps SB19 to SB26 are similar to the steps SA15 to SA22 shown in FIG. 6 description is omitted.

Now it is assumed that an operation is input to reproduce the program recorded in the HDD 107 (step SB1). The program management list setting section 109b2 reads the program management list from the HDD 107 (step SB2), and judges whether or not the program has been viewed (step SB3). In a case where the program has not been viewed, the continuous flag collating means 109b4 confirms whether or not the program is included in a series of programs, and there is at least one program viewed in the past in the series of the programs (step SB15). In a case where the series program has ever been viewed, the image processing control information temporary storage means 109b3 temporarily stores the presently used image processing control information (step SB16). The image processing control means 109b1 sets the viewing flag of the program to “viewed” in the program management list (step SB17). The control means reads the image processing control information of the series program viewed in the past (step SB18), and sets the information to the video processing means 104b (step SB6). Accordingly, the previously viewed series program can be viewed in an image control state at that time. The HDD recording and reproducing means control section 109c starts the reproduction of the program (step SB7).

Here, in a case where there are a plurality of previously viewed series programs, as the image processing control information to be read in step SB18, information having a new update date is used.

According to the above embodiment, in a case where the series program is viewed, when there is a matched continuous flag in the program management list, the user can view even a program that has not been viewed yet in user's favorite display setting.

This invention is not limited to the above embodiment. In the present embodiment, the program management list includes the image processing control information, but may further include subtitle control information and voice control information. In this case, when the program information is linked with voice signal processing control information, output voice can be controlled by voice signal processing control means. In this case, examples of the voice signal processing control information include control information on a sound volume and information of control by an equalizer. Furthermore, when the program information is linked with the subtitle volume information, a subtitle displayed by display means can be controlled by the subtitle control means. Examples of the subtitle control information in this case include on/off setting information of the subtitle.

It is to be noted that this invention is not limited as such to the above embodiment, and constituting elements can be modified and embodied in an implementing stage without departing from the scope of the invention. An appropriate combination of a plurality of constituting elements disclosed in the above embodiment can form various inventions. For example, several constituting elements may be removed from all the constituting elements described in the embodiment. Furthermore, constituting elements of different embodiments may appropriately be combined.

According to the above means, in a case where the viewed program is viewed, the program is reproduced using display setting set by the user during the previous viewing. Therefore, the program can be viewed with a simple operation in user's favorite display setting.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display device comprising:
receiving means for receiving a video signal;
signal processing means for subjecting the video signal received by the receiving means to predetermined signal processing;
video signal output means for outputting the video signal output from the signal processing means to display means for displaying the video signal;
a recording and reproducing unit which stores the video signal output from the signal processing means in a recording medium;
program information extracting means for extracting information of a program received by the receiving means;
image processing control means for controlling the signal processing performed by the signal processing means; and
program management information setting means for storing program management information obtained by associating information of a program to be first viewed, which is extracted by the program information extracting means, with the image processing control information set by the image processing control means.

2. The video display device according to claim 1, wherein the program management information includes a viewing flag indicating whether or not the program stored in the recording and reproducing unit has already been viewed.

3. The video display device according to claim 1, wherein the image processing control means reads the image processing control information of the program from the program management information, and automatically controls image processing, in a case where the viewed program is to be reproduced.

4. The video display device according to claim 1, further comprising:
operation input means for manually changing the image processing control information for use by the signal processing means.

5. The video display device according to claim 1, wherein the image processing control information to be recorded in the program management information is updated into new control information, in a case where the image processing control information is changed by the operation input means.

6. The video display device according to claim 1, further comprising:
image processing control information temporary storage means for temporarily storing the image processing control information of the program being viewed, in a case where the viewed program is to be reproduced, and automatically returning the temporarily stored image processing control information to an image processing unit, after the reproduction of the viewed program is completed.

7. The video display device according to claim 1, wherein the program management information includes control information on subtitle and/or voice.

8. The video display device according to claim 1, wherein the program management information includes a continuous flag indicating a series of programs.

9. The video display device according to claim 1, further comprising:
continuous flag collating means for switching the image processing control information in an image processing unit to the image processing control information used in the program viewed in the past among a series of programs, in a case where the series of the programs are viewed.

10. A video reproduction method having: receiving means for receiving a video signal; signal processing means for subjecting the video signal received by the receiving means to predetermined signal processing; display means for displaying the video signal output from the signal processing means; a recording and reproducing unit which stores the video signal output from the signal processing means in a recording medium; image processing control means for controlling the signal processing performed by the signal processing means; and a control unit for controlling an operation, the method receiving a program and reproducing the program from the recording and reproducing unit under a control of the control unit,
extracting information of the program received by the receiving means; and
storing program management information obtained by associating information of a program to be first viewed, which is extracted by the program information extracting means, with the image processing control information set by the image processing control means.

11. The video reproduction method according to claim 10, further comprising:
reading the image processing control information of the program from the program management information, and automatically controlling image processing, in a case where the viewed program is to be reproduced.

12. The video reproduction method according to claim 10, further comprising:
manually changing the image processing control information of the signal processing performed by the signal processing means via operation input means.

13. The video reproduction method according to claim 10, wherein the image processing control information to be recorded in the program management information is updated into new control information, every time the image processing control information is changed.

14. The video reproduction method according to claim 10, further comprising:
temporarily storing the image processing control information of the program being viewed, in a case where the viewed program is to be reproduced, and returning the temporarily stored image processing control information to an image processing unit, after the reproduction of the viewed program is completed.

15. The video reproduction method according to claim 10, further comprising:
switching the image processing control information of an image processing unit to the image processing control information used in the program viewed in the past among a series of programs, in a case where the series of the programs are viewed.
